(19) United States
(12) Patent Application Publication
(10) Pub. No.: US 2019/0066877 A1
(43) Pub. Date: Feb. 28, 2019

(54) SUPERCONDUCTING JOINTS BETWEEN Bi2212 ROUND AND RECTANGULAR WIRE

(71) Applicant: Alexander Otto, Groton, MA (US)

(72) Inventor: Alexander Otto, Groton, MA (US)

(21) Appl. No.: 16/119,693

(22) Filed: Aug. 31, 2018

Related U.S. Application Data
(60) Provisional application No. 62/552,585, filed on Aug. 31, 2017.

(51) Int. Cl. H01B 12/06; H01B 12/10; H01B 7/22

(52) U.S. Cl. CPC H01B 12/06; H01B 7/223; H01B 12/10

(57) ABSTRACT

A high temperature superconducting joint, a high temperature superconducting wire or tape comprising a high temperature superconducting joint, or an MRI or NMR machine comprising a high temperature superconducting wire or tape comprising a high temperature superconducting joint. Also, methods for producing a high temperature superconducting joint for use in a superconducting wire or an MRI or NMR machine, or other high field generating coil.

### TECHNICAL FIELD

The present invention relates to superconducting joint techniques. The present invention also relates to practical and effective superconducting joint approaches for high temperature superconducting wire or tape, and for advancing MRI and NMR instrument performance.

### BACKGROUND

Superconducting magnets are enabling for NMR and MRI instruments. Currently, Low Temperature Superconductors (LTS) that require liquid helium (LHe) dominate NMR and MRI magnets. But High Temperatures Superconductors (HTS) are indispensable for >1-GHz (>23.5 T) NMR magnets and make it much easier than LTS to design and operate LHe-free MRI magnets, as well as a host of other higher field magnet systems. Market analysis for HTS materials and projections forecast that over the next 3 to 5 years the global NMR market will grow at an annual rate of approximately ten percent and the global superconducting MRI market will exceed six billion dollars per year.

Superconducting joints are essential components of many of these important, commercial superconducting magnet systems, where extreme temporal invariance and spatial field uniformity are essential. Although expensive DC power supplies can provide some of the constant currents required in these high field coils to meet stringent requirements, superconducting joints (SCJ) combined with persistent current switches (PCS) are by far the most economical and superior way to achieve the most constant and uniform magnetic fields. As a results SCJ's are widely utilized with Low temperature superconducting magnet systems comprising many of today's clinical and research MRI as well as NMR imaging instrument platforms. The lack of a suitable superconducting joint capability with HTS materials and conductors has impaired their adoption for usage in advanced forms of these types of instruments.

Although superconducting joint techniques are well established and widely applied with LTS materials, to date, and in spite of considerable effort (see references at the end of this disclosure), there has not yet been developed a practical and effective superconducting joint approach for any high temperature superconducting wire or tape, which otherwise hold a great deal of promise for advancing MRI and NMR instrument performance, operational ease and cost. Methods and devices described herein address these issues.

### SUMMARY

Specific embodiment described herein are directed to a high temperature superconducting joint comprising: two tapered Bi2212 wire ends, each of the ends comprising an angle of less than about twenty degrees relative to the longitudinal axis of each of the wires; an overlap region between the two wire ends; a gap between the wire ends within the overlap region; the tapered ends of the wires forming planar surfaces on either side of the gap and defining the gap plane; an average thickness of the gap being less than about 100 micrometers; wherein the gap contains aligned Bi2212 grains; and a silver over-layer encapsulating the wire ends, the overlap region, and the gap, the silver over-layer comprising from about 0.05 millimeters (mm) to about 2 mm in thickness.

Specific embodiment described herein are directed to a magnetic resonance imaging (MRI) machine or Nuclear magnetic resonance (NMR) machine comprising: a high temperature superconducting wire or tape comprising: at least one high temperature superconducting joint, the joint comprising: two tapered Bi2212 wire or tape ends, each of the tapered ends forming a planar surface and comprising an angle of less than about twenty degrees relative to the longitudinal axis of each of the wires; an overlap region between the two wire or the tape ends; a planar gap between the wire or the tape ends within the overlap region, an average thickness of the gap being less than about 100 micrometers; wherein the gap contains aligned Bi2212 grains; and a silver over-layer encapsulating the wire ends, the overlap region, and the gap, the silver over-layer comprising from about 0.05 millimeters (mm) to about 2 mm in thickness.

Specific embodiment described herein are directed to a method for producing a high temperature superconducting joint, the method comprising: tapering two Bi2212 wire ends such that each of the ends comprises an angle of less than about twenty degrees relative to the longitudinal axis of each of the wires; overlapping the wire ends, forming an overlap region between the two wire ends; placing the wire ends such that there is a gap between the wire ends within the overlap region, an average thickness of the gap being less than about 100 micrometers; filling the gap with Bi2212 liquid by wetting during melt texturing of Bi2212 grains, thereby forming aligned Bi2212 grains; and encapsulating the wire ends, the overlap region, and the gap, with a silver over-layer, the silver over-layer comprising from about 0.05 millimeters (mm) to about 2 mm in thickness.

These and additional objects and advantages of the invention will be more fully apparent in view of the detailed description.

### BRIEF DESCRIPTION OF THE DRAWINGS

The embodiments set forth in the drawings are illustrative and exemplary in nature and not intended to limit the invention defined by the claims. The following detailed description of the illustrative embodiments can be understood when read in conjunction with the following drawings, in which:

FIG. 1 illustrates the typical dependence of FIN grain to grain critical current density, Jc, as it depends on the misorientation angle between the crystal structures of abutting grains;

FIG. 2A illustrates a design of Bi2212/Ag and strip reinforced Bi2212/Ag wire in a rectangular configuration;

FIG. 2B illustrates a design of Bi2212/Ag and strip reinforced Bi2212/Ag wire in a round configuration;

FIG. 2C illustrates a cross-section of Bi2212/Ag in a rectangular configuration;

FIG. 2D illustrates a cross-section of Bi2212/Ag and strip reinforced Bi2212/Ag wire in a rectangular configuration;

FIG. 2E illustrates a cross-section of Bi2212/Ag wire in round a ration;

FIG. 2F illustrates a cross-section of strip reinforced Bi2212/Ag wire in a round configuration;

FIG. 3A illustrates the overlap region and prepared wire ends of a rectangular configuration;

FIG. 3B illustrates the overlap region and prepared wire ends of a round configuration;

FIG. 4 illustrates the two ends of a rectangular cross-sectioned Bi2212 wire from view A in FIG. 3A;

FIG. 5A illustrates an example of a “B” direction view, regarding the view B of FIG. 3A, of two assembled and melt textured joints between rectangular reinforced wire ends;

FIG. 5B illustrates additional aspects of an example of a “B” direction view, regarding the view B of FIG. 3A, of two assembled and melt textured joints between rectangular reinforced wire ends;

FIG. 6A illustrates the process concept step one of three;

FIG. 6B illustrates the process concept step two of three;

FIG. 6C illustrates the process concept step three of three;

FIG. 7A illustrates prepared ends of rectangular reinforced Bi2212 based wires;

FIG. 7B illustrates additional aspects of prepared ends of rectangular reinforced Bi2212 based wires;

FIG. 8A illustrates a simple joint at a stage of assembly, this one without use of Bi2212 reservoirs or strip reinforcement of the joint;

FIG. 8B illustrates a simple joint at another stage of assembly, this one without use of Bi2212 reservoirs or strip reinforcement of the joint;

FIG. 8C illustrates a simple joint at yet another stage of assembly, this one without use of Bi2212 reservoirs or strip reinforcement of the joint;

FIG. 8D illustrates a simple joint at yet another stage of assembly, this one without use of Bi2212 reservoirs or strip reinforcement of the joint;

FIG. 9 illustrates the placement of Bi2212 reservoir tapes on each side of the joint region, with the silver foil acting as the trough holding them in place;

FIG. 10 illustrates melt textured joint samples spanning specific configurations of Table 1;

FIG. 11 illustrates the Ic test set up for a sample with all the components described and a 5.7-degree taper, strip reinforcement over the joint, 2 Bi2212 reservoir tapes, and silver foil over layer;

FIG. 12A illustrates wire ends with taper cuts brought together;

FIG. 12B illustrates the assembled joint sample ready for melt texture heat treatment;

FIG. 12C illustrates the joint after heat treatment; and

FIG. 12D illustrates Ic data at three temperatures.

### DETAILED DESCRIPTION

Specific embodiments of the present disclosure will now be described. The invention can, however, be embodied in different forms and should not be construed as limited to the embodiments set forth herein. Rather, these embodiments are provided to illustrate more specific features of certain aspects of the invention to those skilled in the art.

Unless otherwise defined, all technical and scientific terms used herein have the same meaning as commonly understood by one of ordinary skill in the art to which embodiments of this invention belong. The terminology used herein is for describing particular embodiments only and is not intended to be limiting of the invention. As used in the specification and appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about,” which is intended to mean up to ±10 % of an indicated value. Additionally, the disclosure of any ranges in the specification and claims are to be understood as including the range itself and also anything subsumed therein, as well as endpoints. Numerical ranges as used herein are intended to include every number and subset of numbers within that range, whether specifically disclosed or not. Unless otherwise indicated, the numerical properties set forth in the specification and claims are approximations that can vary depending on the desired properties sought to be obtained in embodiments of the present invention. Notwithstanding that numerical ranges and parameters setting forth the broad scope of embodiments of the invention are approximations, the numerical values set forth in the specific examples are reported as precisely as possible. Any numerical values, however, inherently contain certain errors necessarily resulting from error found in their respective measurements.

Specific embodiment described herein are directed to a method for producing a high temperature superconducting joint with Bi2212. A high temperature Bi2212 -based superconducting joint refers to a joint that contains predominantly Bi2212, and exhibits resistance up to a temperature of about 70 K, that is below 10⁻⁹ ohm, irrespective of the compositions of the wires coining into the joint.

In a broad sense when it comes to joining materials together, liquids offer much easier options for making good joints, for example in welding, soldering and brazing, and even with many kinds of gluing, because liquids can readily flow to fill the gaps between the mating surfaces, and they can also wet the surfaces and even form chemical bonds between the atoms of the liquid and solid at the solid's surfaces. Upon solidification, this structure is locked into place and the liquid is replaced by a strong, continuous material that spans the gap between the surfaces of the two-joined object. Solid state joining techniques are also used, but typically require higher pressures, longer times, more exacting conditions and controls, while still often resulting in local variations in bond and gap filling material quality, uniformity and functionality.

The lack of progress with HTS superconducting joints has been primarily due to the chemistries, crystal structures and specific grain configurations (a.k.a. textures) that must be attained to achieve high current densities in HTS wires and tapes including the region across the gap between two HTS wire ends. HTS materials are brittle oxide ceramics, so they cannot be plastically deformed together to make joints without fracture of the filaments leading into the joints. Additionally, the individual HTS crystals, or “grains” comprising the superconducting pathways in a wire or tape must be aligned in very particular ways relative to each other and the wire axis so as to achieve high current density continuous pathways that make a superconductor useful. For the HTS materials presently developed into tape forms and commercially available, achieving broad based bonding and contact across the gap, as well as texture have been highly problematic. The solid-state epitaxial texturing approaches in the case of the so called ReBCO class of HTS materials in tape form (2G), and the deformation based texturing case of “Bi2223/Ag” tape (1G) do not support melting or solid-state sintering at easy to use conditions. Specifically, they cannot be readily melted and solidified to take advantage of wetting mechanisms while also achieving texture and the kinds of crystal compositions required for achieving high current, robust joints with relatively small transfer lengths, and sizes.

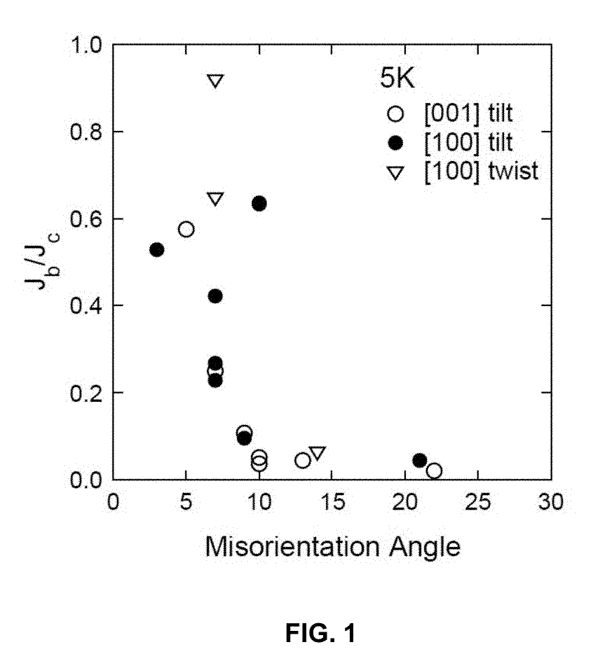

FIG. 1 illustrates the typical dependence of HTS grain to grain critical current density, Jc, as it depends on the misorientation angle between the crystal structures of abutting grains. It is evident, and very well known, that average misorientation angles below about 10-15 degrees provide for the highest critical current densities. Note that current density defines the upper limit of current density above which the zero resistance functionality of the superconductor is lost and its resistance increases rapidly with increasing current density—effectively limiting the practical utility of the superconductor to be below its critical current density.

FIG. 1 illustrates published data indicating the effect of increased misorientation angle between HTS crystals on critical current density between the crystals—showing that in general, for high current density across crystal, aka grain boundaries, misalignment of less than 10 degrees relative to each connected neighbor is preferred. This also dictates that for forming high Jc joints by spanning the joint gap with superconducting grains, those grains must also on average have a certain number or greater of low angle connections.

Reference below for FIG. 1:

1 D. Dimos, P. Chaudhari, and J. Mannhart, Phys. Rev. B, 41, 4038 -4049, (1990); D. Dimos, P. Chaudhari, and J. Mannhart, and F. K. LeGoues, Phys. Rev. Lett., 61, 219, (1988); J. Mannhart, P. Chaudhari, D. Dimos, C. C. Tsui, and T. R. McGuire, Phys. Rev. Lett. 61, 2476, (1988).

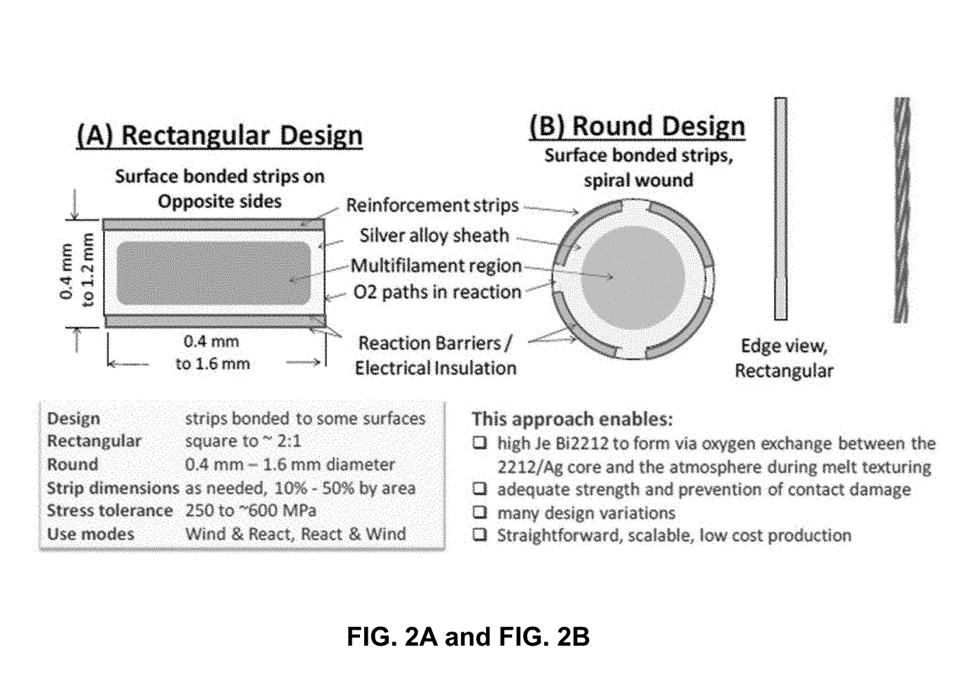

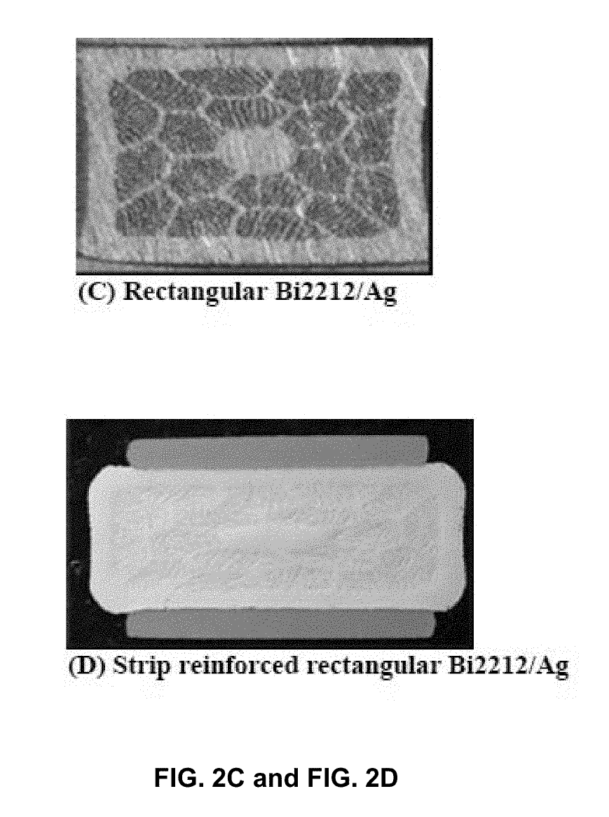

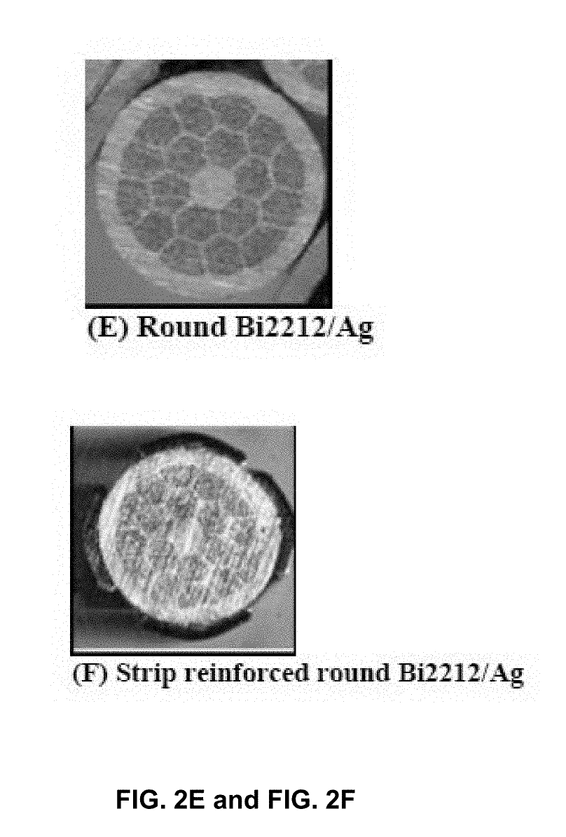

A technology has recently been invented for producing strong superconducting round and rectangular wires based on the Bi2212 HTS material (U.S. patent application No. 15/043,145, now Pat. No. 9,793,032 ). A cross section of rectangular and round versions of this strong wire type are illustrated in FIGS. 2A-2 F, showing that reinforcement is applied to outer surface of portions for the round wires in a helical wrap configuration, while in the case of rectangular wire, they are applied along the wire axis on one, two or three of the four sides of wire. These designs allow oxygen access into and out of the Bi2212 wire cores from the atmosphere as required to form high current density forms of Bi2212.

FIGS. 2A-2F illustrate designs and cross-sections of Bi2212/Ag and strip reinforced Bi2212/Ag wire in round and rectangular configurations.

The inventor has discovered that among HTS materials in wire and tape forms, the unique properties of the Bi2212 HTS material in silver sheathed, multifilament wire form in combination with a novel joint architecture enables the formation of practical high strength, short length, robust superconducting joints between the ends of multifilament Bi2212 wires, projecting from compact high field coils—in such a way that renders them highly useable as persistent current mode coils.

It is an objective of this invention to make superconducting joints between the ends of these wires, as well as between the ends of any other 2212/Ag wire types, as well as possibly other wire types, so that the maximum current supported by the wire is not lower than what the wire must support in the coil where magnetic fields are higher and therefore critical currents are lower. For example, in many cases a joint with at least half the critical current of the wire at the same test conditions will be adequate because the bulk of the wire will be in a much higher magnetic field, where Ic is suppressed, as compared to the magnetic field at the location of the joint some distance away from the highest field portions of the coil into which the wires that form coil go. Of course, it is most advantageous to make joints that exhibit Ic's of the same level as the wires and strengths that are also in the same regime, so that robust coils can be realized without the need for restrictions on where the joints may be placed. However, for high field magnet applications strong joints between strong wires is the preferred approach—which is also an embodiment of this invention.

Another critical factor for SCJ's is the size and length of the joint, where in the case of compact coils that are inserted into LTS coils to boost their fields, the joints cannot be too long for practical space usage inside the cryo-envelope of the coil, and the joint cannot be so bulky as to take up or exceed the available space in the cryostat and outer coil—that is typically wound with LTS NbTi or Nb3Sn.

The superconducting joints of this invention occupy very little additional space as compared to the wires coming into the joint, for example, the joint regions are short, less than 10 cm and preferably less than 5 cm in length, and their total widths, thicknesses or diameters are less than 3 times the widths, thicknesses or diameters of the constituent wires.

### Innovation

Concept for Superconducting Bi2212 Joints

The Bi2212 superconducting joint is enabled by my discovery of a way to harness a unique attribute of Bi2212 among all HTS wire materials, whereby it can be melted from any prior phase state and sintered condition, followed by solidification to produce fully sintered, high Jc Bi2212 with the required crystallographic texture and sufficient grain to grain bonding to transfer high currents across low angle grain boundaries.

I discovered that if two wire end surfaces are prepared with small angles relative to the wire axis and with the exposed areas of the Bi2212 filaments greatly enlarged, then when these surfaces are brought together with a very narrow, planar gap separating them, then a superconducting joint is formed by applying a melt texturing cycle. I have also discovered that even better results are obtained if a small reservoir of Bi2212 is added so that molten Bi2212 can wick into the small angle gap during the early part of melt texturing.

Among all HTS materials in wire and tape forms, the unique properties of the Bi2212 HTS material in silver sheathed, multifilament wire form in combination with a novel joint architecture now enables the formation high strength, short length, robust superconducting joints between the ends of multifilament Bi2212 wires, projecting from compact high field coils in such a way that renders them most useable as persistent current mode coils.

### Key Features of Specific Embodiments of the Invention

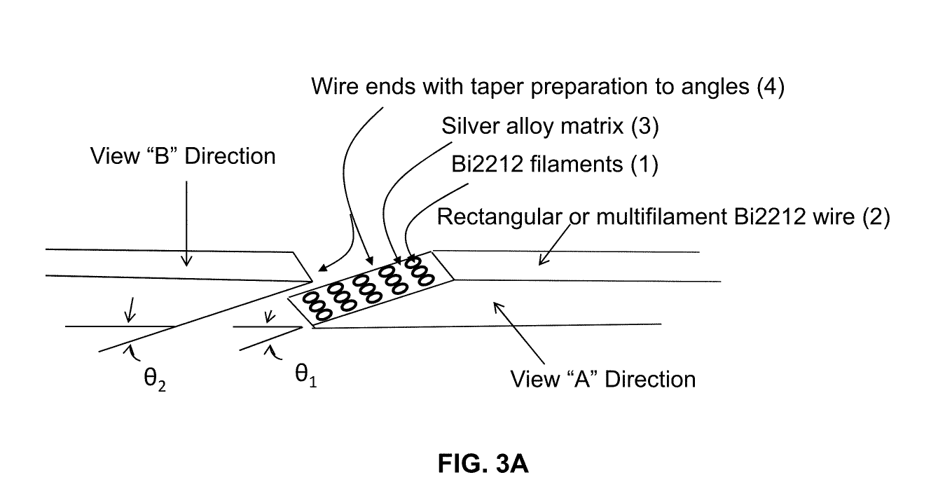

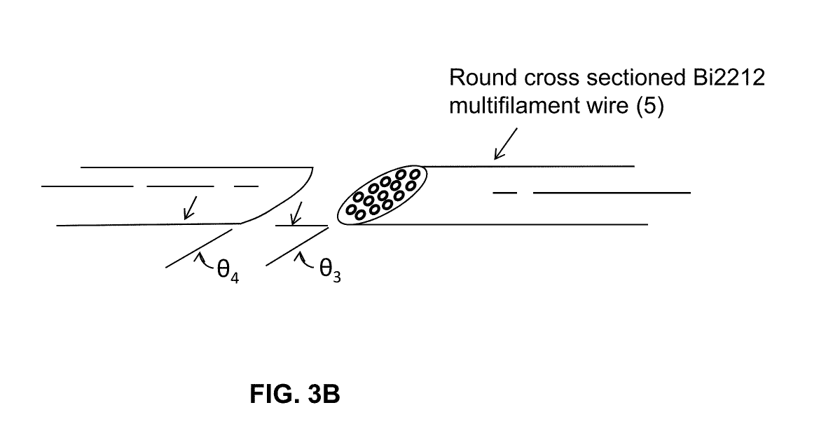

With reference to FIGS. 3A, 3B, 4, 5A, 5B, 6A, 6B, and 6C, key features of this invention include the following:

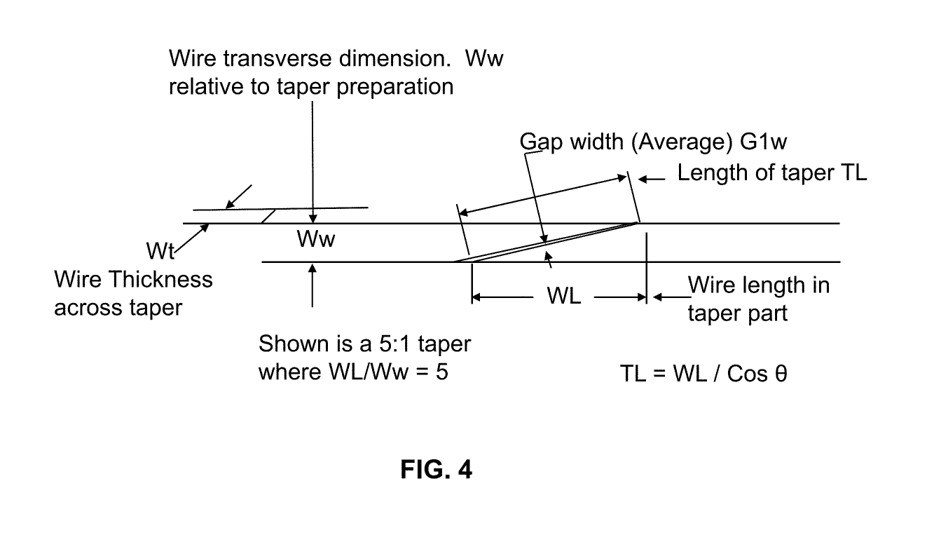

1 ) An overlap region (FIGS. 3A, 3B, and 4 ): that is tapered, with a mating configuration between the two wire ends, through the Bi2212/Ag multifilament wire core at each end of the wire to be joined,

2 ) A sufficiently thin gap between the mated overlap region (FIGS. 3A, 3B, and 4 ): to trigger effective melt texturing in the gap, that also occurs in each filament, partially and approximately aligning the c-planes of the Bi2212 grains in the gap with the plane of the gap, for example, as a guideline, a gap with an average thickness of less than about 100 micrometers is preferred.

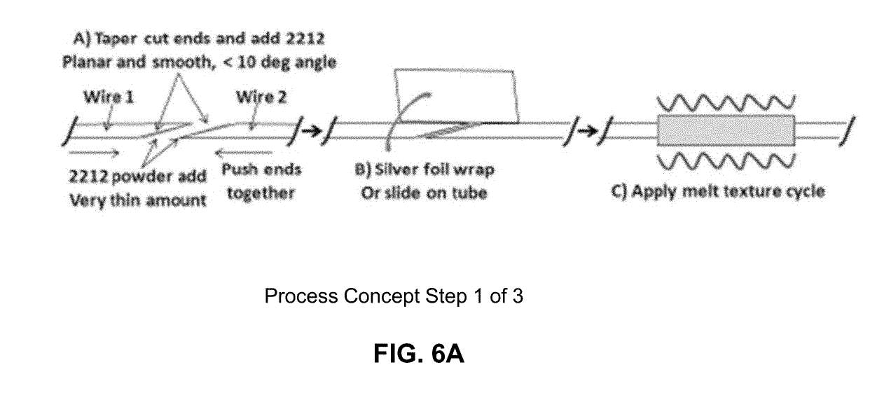

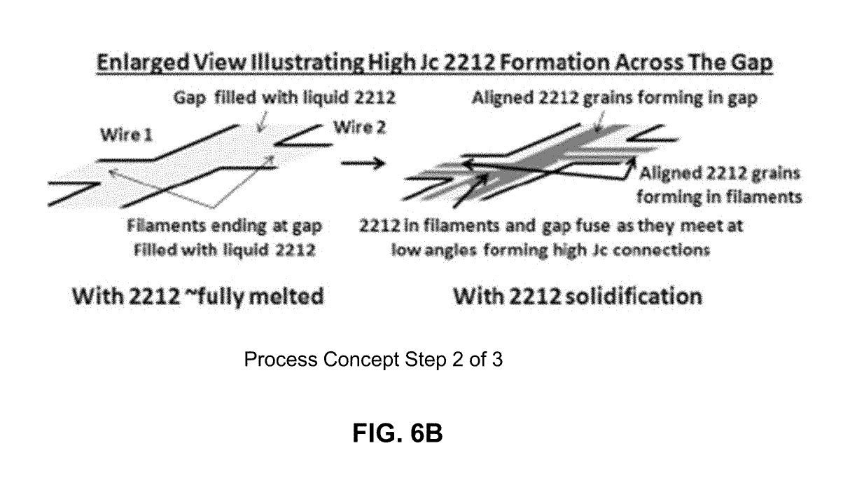

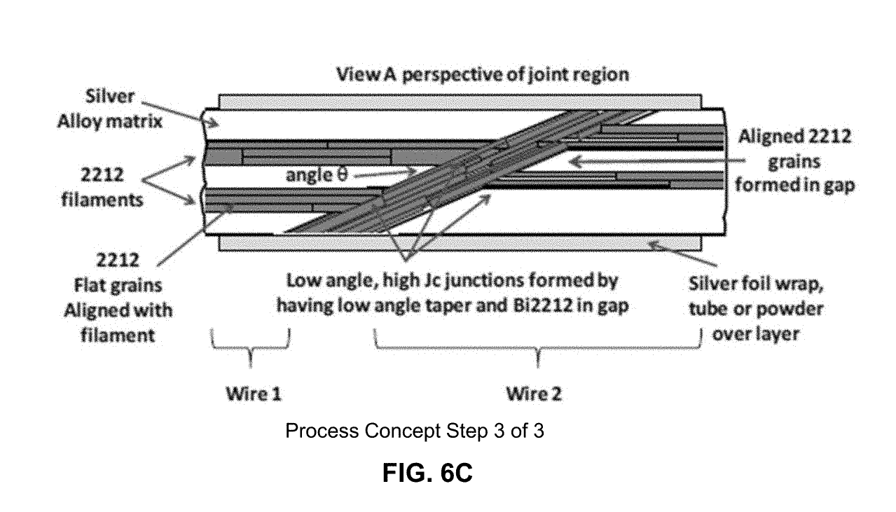

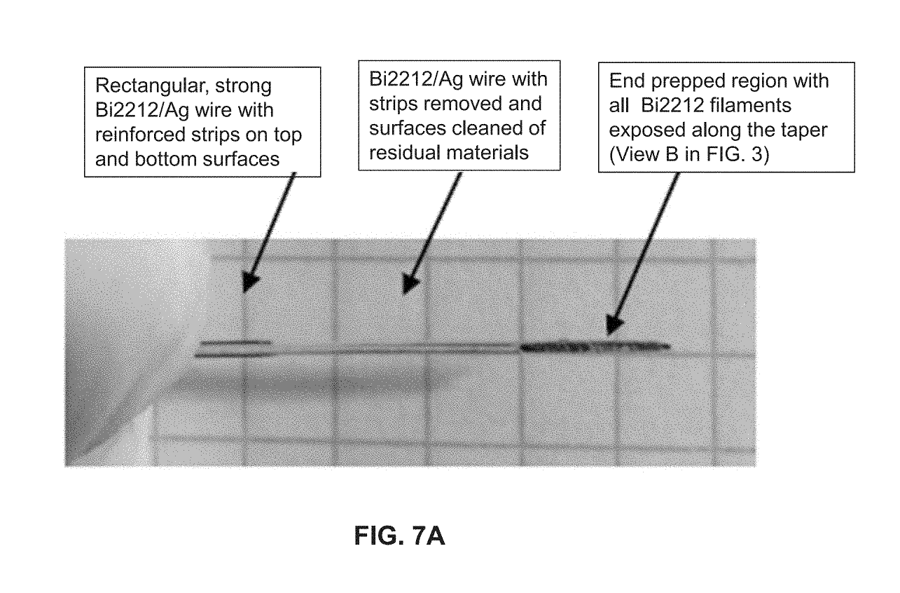

3) Tapers that are of appropriately low angles relative to the wire axis (FIGS. 3A, 3B, and 4 ): to enable sufficiently large, bridging contact areas and formation of high current density grain to grain junctions across the gap as illustrated in FIGS. 6A, 6B, and 6C, where these angles are less than at least 20 degrees and preferably less than about 10 degrees, or between about 1 degree and about 20 degrees, or between about 5 degrees and about 15 degrees, or between about 7 degrees and about 10 degrees, or between about 1 degree and about 10 degrees. But where the angles are still large enough for all filaments to enter the gap region and form high Jc connections to the melt texture formed Bi2212 grains in the gap that are approximately aligned with the gap plane. In specific embodiments, the Bi2212 grains of a joint as described herein are on average aligned to within about plus or minus about 20 degrees of the gap plane, a plane extending in the direction of the length of the gap, approximately perpendicular to the gap thickness, which is a distance between the tapered wire ends. In specific embodiments the Bi2212 grains of a joint as described herein are on average aligned to within about plus or minus about 10 degrees of the gap plane, or between about 1 degree and about 2.0 degrees, or between about 5 degrees and about 15 degrees, or between about 7 degrees and about 10 degrees, or between about 1 degree and about 10 degrees. An average gap thickness in specific embodiments is less than about 100 micrometers, and in others, is less than about 50 micrometers.

4) Sufficient filling of the gap with Bi2212 liquid (FIGS. 3A, 3B, 4, 5A, 5B, 6A, 6B, and 6C): by wetting during melt texturing of Bi2212 grains—a vital feature of specific embodiments of this invention, enabling the formation of aligned grains as described above.

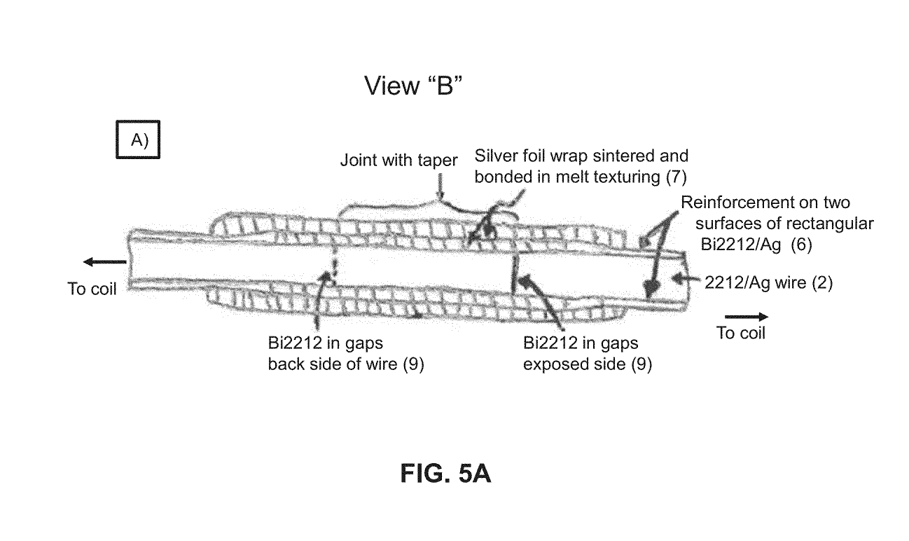

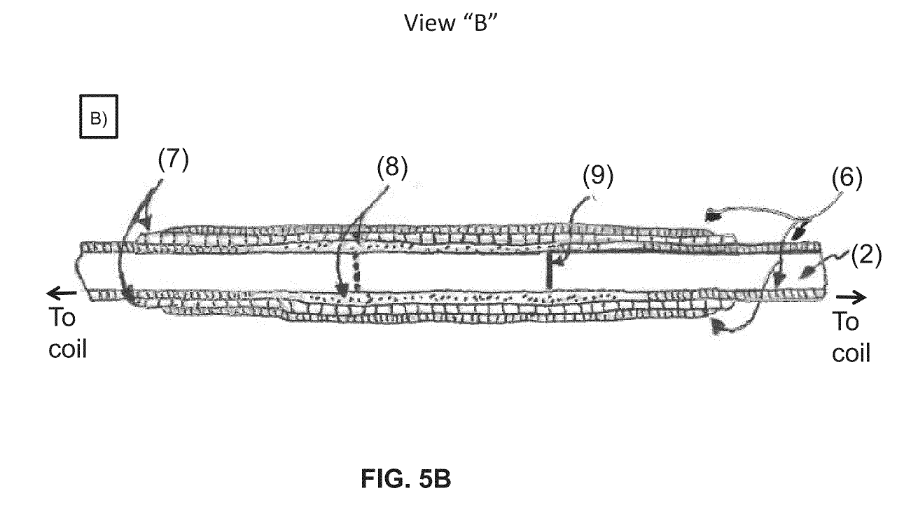

5) Use, as needed, of a Bi2212 reservoir (FIG. 5B): that is located in the immediate vicinity of the overlap region and gap so that it can supply molten Bi2212 during melt texturing to fill the gap in order to avoid drawing out too much Bi2212 liquid from the filaments that end at the gap. This reservoir may be a thin Bi2212/Ag mono or multifilament tape with the silver removed from the side facing the joint or it may be Bi2212/Ag in powder or pressed/sintered/cast strip form. In some cases, this reservoir may in fact not be required.

6) Use of a silver over-layer to encapsulate these components (FIG. 5A,B): of total thickness in the 0.05 mm to 2 mm range, it contains the molten 2212 during melt texturing and enables the required oxygen exchange, while providing protective encapsulation, strengthening, electrical shunting and thermal stabilization to the joint region.

7) Use, as needed, of joint strengthening reinforcement strips (FIG. 5B): of the same types as what are used to reinforce the rectangular wires as described by U.S. patent application Ser. No. 15/043,145, and with the strips laid onto to opposing sides of the rectangular reinforced wire joint, and in the case of the round wire, with strips that are wrapped in a low angle helix around the nominally cylindrically-shaped, silver encased joint region.

With reference to FIGS. 6A, 6 B, and 6 C, the bundled joint region is subjected to a melt texturing cycle during which initially the 2212 in the wire and at the interface melts filling the spaces with liquid. At the start of solidification, 2212 grains nucleate in the filament cavities and gap regions, followed by growth oriented along the wire axis in the filament cavities as occurs in standard melt texturing, and with growth along the gap cavity plane as shown in FIG. 6. If the gap cavity is oriented at a sufficiently small angle relative to the filaments in the wire, then the gap's Bi2212 grains intersect and fuse together with the grain growing out of each filament at sufficiently low angles to form high Jc connections across the gap over a large enough area to transport the wire's full supercurrent without any voltage increase—FIG. 6C.

The melt texture/sinter feature of 2212 provides critical advantages compared to 1 G and 2 G when it comes to making superconducting persistent current joints because neither of these HTS material types can be reversibly melted and solidified to produce a high Jc structure. Mechanisms available to help form high current persistent current joints with multi-filament Bi2212 wire by our approach include:

1) Bi2212 liquid wets silver and as a result it can flow between the proximal surfaces of the abutting wire ends to be joined and completely fill that gap as long as there is adequate supply of liquid.

2) Upon solidification, large (up to 100 μm), but thin (below 5 μm thick),—2212 plate-shaped grains form, with the high current density direction along the width and length of each grain.

3) The large 2212 grains align with the shape of the space they grow in, so that the high Jc orientation of each grain is along the extended direction of the space, for example, along the axis of the filament cavities in silver, and in the case of joints, along plane, or long direction of the gap.

4) Misalignment between 2212 grains can be much larger while still attaining high Jc, than with 2 G, 10° to 20°, compared to <5°, allowing greater flexibility of joint design.

5) The large grains (>100 μm can span gaps effectively by growing across them.

6) The 2212 grains can also penetrate and grow through silver, as well as bend, and as a result perfect indexing between each filament position of one wire end with the other is not be required in order to achieve high Jc connections.

FIGS. 3A and 3 B illustrate the overlap region and prepared wire ends to expose all the Bi2212 filaments, and increase their effective contacting areas when the ends are brought together in assembly to form a thin gap with some local contact. Lower angles enable larger contact area and lower angle junctions between Bi2212 grains that are formed and aligned within the filaments and that are formed in the gap aligned with the plane of the gap.

FIG. 4 illustrates the two mated ends of a rectangular cross-sectioned Bi2212 wire from View A in FIG. 3A—illustrating the low angle, small gap configuration in which the wires entering the joint so that their axis are approximately aligned. As shown, there is a gap width that is also the gap thickness, the arrows indicating the direction of the gap thickness, to which the gap plane is approximately perpendicular. The gap can be of equal thickness along the lengths of the wire ends, or can be slightly angled. The average gap thickness in specific embodiments is less than about 100 micrometers, or less than about 50 micrometers, or less than about 25 micrometers, or from about 1 to about 100 micrometers, or from about 10 to about 80 micrometers, or from about 25 to about 75 micrometers, or from about 40 to about 60 micrometers, or from about 10 to about 40 micrometers.

FIGS. 5A and 5 B illustrate an example of “B” direction views, as it relates to FIG. 3A, of two assembled and melt textured joints between rectangular reinforced wire ends, a) with silver over-layer “7 ” and Bi2212 in the gap, but without reinforcement across the joint or a Bi2212 reservoir and b) with reinforcement strips “6 ” added that span the joint region and two Bi2212 reservoirs added “8 ” as shown between the wires being joined and the silver over-layer “7 ”, This Bi2212 reservoir can be a thin Bi2212/Ag wire which has had the Bi2212 on the side facing the joint exposed, or a Bi2212 powder or strip, with or without added silver, that is coated or placed onto the abutting wire end regions as shown. In some cases, additional small amounts of Bi2212 powder may be added or introduced into the gap region by for example coating the taper surfaces with this powder before bringing them together to form the gap, or a thin, for example a 10 to 100 micrometer thick sheet or strip of dense, non-particulate form of Bi2212, which then serves as in in-gap reservoirs of Bi2212.

FIGS. 6A, 6B, and 6C illustrate: A) the process concept in three main steps, B) the mechanism by which high Jc 2212 can be made to form across the gap between the exposed filament ends, using the low angle, thin gap to form aligned Bi2212 grains in the gap from the melt there, that are also at relatively low angles to the Bi2212 grains forming by melt texturing near the ends of the filaments and projecting into and bonding to the Bi2212 grain formed there and (C) the finished melt textured structure with high Jc, low angle junction between the Bi2212 grains formed in the gap and the Bi2212 grains formed at the filament ends and projecting with small angles into the gap, relative to the elongated direction of the gap.

### JOINT FABRICATION PROCESS AND TECHNIQUE

The following is the process for making superconducting joints using rectangular, strip-reinforced Bi2212/ Ag wire as an example. The same technique is applicable to rectangular Bi2212/Ag wire as well as both 2212/Ag and strip reinforced 2212/Ag round wires.

### OVERVIEW

1) Cut the Bi21212-based wire ends to appropriate lengths needed to fit joint in intended location

2) Remove all reinforcement strips from regions that will comprise the joint

3) Clean remaining residual materials from exposed Bi2212/Ag surfaces

4) Prepare mating wire ends with much larger areas exposed for each filament, for example via low angle tapers

5) Bring the wire ends together so they mate to form a thin gap

6) If needed, place Bi2212 reservoir(s), Bi2212/ Ag tape, powder or bulk solid, so they contact some gap edges or the interior of the gap

7) Apply silver over-layer foil, tube or pressed powder so it encapsulates and extends beyond the joint, and if joint reinforcement is to be used, extend the silver all the way over and beyond the strip ends on the reinforced wires. In specific embodiments of the joint, the silver over-layer extends beyond the overlap region along the length of each of the wire ends for a distance of up to 10 centimeters.

8) Place reinforcement strips that span the joint region and overlap the strips on the wires, with silver over-layer between the joint and wire reinforcement strips

9) Apply hoop stress or View B direction compression technique to hold the joint components in form contact with each other, and minimize gap thickness during melt texturing.

10) Place joint region or entire coil from which wires emerge into melt texturing equipment and melt texture

### DETAILS ABOUT EACH STEP

1) The wire ends would typically project from the coil in which they are wound, and they must be cut, for example using precision shears, to the proper length and preferably with a clean 90-degree orientation relative to each wire's axis at the point where it enters the region. If the wire ends have set to the curvature of the coil, each end that will be in the joint region can be straightened. The Bi2212 in the wires may be in a state prior to melt texturing or in a fully melt textured state.

2) The reinforcement strips are peeled back and removed from the end regions that will be joined. The strips are first notched at the intended limits of their removal, followed by peeling each one up with for example a sharp edge starting at the cut end of the wire.

3) The exposed Bi2212/Ag wire surfaces at each of the two ends are cleaned of residual materials from the strip using for example mechanical abrasion, chemical means, ultrasonic cleaning, and wiping.

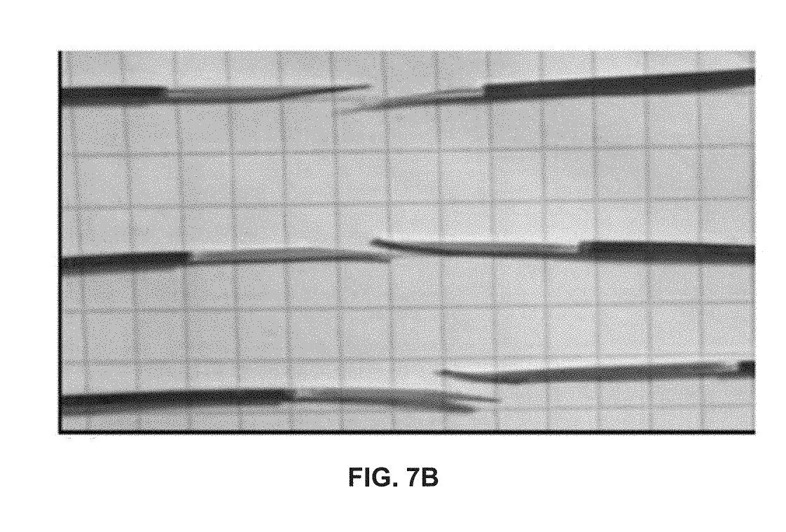

4) Each Bi2212/Ag end is then prepared to expose much larger areas of the Bi2212 filaments than what are exposed across a 90-degree view of the cross-section relative to the wire axis. In one approach, the end preparation produces a low angle (relative to the wire axis) flat surfaced, planar taper in which the cross-sectional area of each filament is greatly increased compared to its 90-degree cross-section area, and in which substantially all the filaments are exposed in this manner. This type of taper end prep may be achieved using a precision shear, mechanical abrasion, micro-sawing, chemical dissolution or a combination of these. With rectangular wire, the taper may be either along its width or thickness direction. The taper prep is also completed on each wire end so their shapes are opposite of each other, allowing them to be brought together as shown in FIGS. 7A and 7 B to form a very thin gap between their prepped ends. The length of each taper region may be in the range of about 3:1 to 25:1 comparing the taper length to the width/thickness/diameter of the wire, and the corresponding taper angle range is about 2 degrees to 20 degrees.

5) The wire ends can be brought together, to check the goodness of the fit, as well as to prepare for assembly of all the components. When all the components are readied, they are assembled into the joint configuration. This procedure may be assisted by using precision fixtures that have the means to hold each component in its intended location as it is placed there and where it must reside until all the components are bonded together by the melt texturing heat treatment. The two ends of the multifilament Bi2212 wires are prepared so that their tapers are in opposite direction allowing them to mate well when they are brought together, forming a thin gap between the flat taper surfaces, while also enabling the two wires coming into the joint region to be approximately coaxial at the entry point into the joint region, even if they are curving into the joint from the curved contour of the coil.

In order to include rectangular, round and other cross-section shaped wires in this specification, taper here refers to the angle of deviation of the external end surfaces of the wires from their wire axis, defined as theta (θ). In order to attain good mating with minimal deviation of wire axis through the joint, in FIG. 2, θ₁˜θ₂˜and θ₃˜θ₄. The typical gap should be less than the typical lengths of the Bi2212 grains that form in melt in melt texturing, for example, typically less than about 100 micrometers.

6) If a Bi2212 reservoir is to be used that is comprised of thin Bi2212/Ag tape, one surface of that tape is treated to remove the silver outer jacket and expose the underlying Bi2212 in mono or multi filament form. The Bi2212 wire used for this may be either in a fully melt textured form or the pre-melt textured from where the Bi222 is still in its precursor powder or densified powder form. The tape is then cut to the appropriate length, with may be longer, the same as, or shorter than the length of the taper/joint region.

In one form of silver over-layer, silver foil or sheet is prepared by cleaning it and cutting it to size, also possibly by annealing it to make it highly compliant and bendable. This type of over-layer can be applied by wrapping it around the joint area using a mechanical assist with added tension, and precision folding blades, and such that its edges end either ends along the Bi2212/Ag wire portions or overlap a short section of each wire where the reinforcement strips have not been removed. Compression with some heat, for example 200-500 C may be applied for short time once wrapping is completed to somewhat sinter the foil components to each other and to the Bi2212/Ag underneath, locking the components in place and helping to complete the rest of the assembly without loss of configurational integrity. In the case of silver powder, a powder pack is applied and compressed onto the joint, encapsulating it and if it is done with a modest amount of heating, it also sinters together the power and contacting components.

8) If required, reinforcement strips may be placed on the 2212/Ag wire surfaces going into the joint region strips and spanning the joint region, as placed on one or both sides where there is reinforcement on the rectangular wire away from the joint.

9) Hoop compression is applied to the assembled joint by for example wrapping it with a low coefficient of thermal expansion (CTE), high strength, high modulus strip similar to the strip types used to reinforce the wire, while the strip is in tension. Compression can also be achieved by using for example spring loaded fixtures or screw down fixtures that maintain their strength during the melt texturing treatment.

10) Melt texturing is accomplished using a small furnace set up, with controlled atmosphere, and the two wires projecting out of its sides and leading back to the coil, that then only melt textures the Bi2212 in the joint region, if for example the rest of the coil has already been melt textured, or the entire coil may be placed in a furnace set up, operating at 1 atm total gas pressure or at over pressure conditions, to achieve high Jc Bi2212 simultaneously in the coiled wire, as well as the joint region. The compression strip or compression fixture is left on the joint during melt texturing to provide additional compression and assists consolidation and bonding. After cool down, they can be removed.

Example 1: Rectangular reinforced wire samples were prepared and tested in the following way

B12212 wire feedstock: Rectangular reinforced wire comprised of Bi2212/Ag with a width of 1.35 mm and thickness of 0.55 mm, and containing 1.37 mm wide by 0.1 mm thick diffusion bonded strip was used. It was cut into pieces in both pre-melt-textured and post melt textured conditions. The approximate volumetric amount of Bi2212 in the Bi2212/Ag wire was 25%, but this technique applies to wires with any amount of Bi2212 in the 5% to 80% range.

Strip removal: The strips were removed from one end of each reinforced wire piece at between 1.5 and 3.5 cm from the ends targeted for joining.

Preparation of reservoir Bi2212/Ag tapes: Constituent Bi2212/Ag rectangular wire was also rolled in its pre-melt-textured condition to thicknesses of about 0.05 to 0.13 mm and widths of 1 to 1.5 mm, for use as the Bi2212 reservoir. One side of this tape was mechanically abraded to remove the outer silver layer and expose the underlying Bi2212-removing about 0.015 mm from its thickness. Lengths were cut from this piece to be between 0 and 1 cm longer than the targeted overlap regions of the planned joints.

Preparation of silver foil for over layer: Silver foil of thickness 0.05 m was prepared for use as the over layer by solvent cleaning, abrasion with 400 grit SiC paper, re-wiping with solvent and annealing for 1 hour at 300 C in air. The silver in the foil had a specified purity of 9.99%, though some types of silver alloys may also be used, for example containing small amounts of magnesium, copper, or aluminum. Foil pieces were then cut into sizes so they could provide two wrapped layers around each of the planned joints, and wide enough to either end just before reaching each edge of the strips on the wires, or exceeding about 0.5 to 1 cm beyond the strip ends.

Preparation of taper ends: The reinforced Bi2212 wire sample ends with the strip removed were sheared using a high precision shear to form the type of taper surface shown in FIGS. 3A and 3B, such that all the Bi2222 filaments were exposed as seen in the photo of FIG. 7A, and with the 0.55 mm thickness of the Bi2212/Ag wire corresponding to the width of the taper planes. Samples were sheared in this manner with taper angles ranging from 90 degrees (0:1) to about 2.9 degrees (20:1). The surfaces formed by the shear cut were also as needed, further rendered flatter by additional mechanical abrasion using a fixture to avoid damaging the wire structures. Some of these samples are shown in the photos of FIGS. 7B, illustrating the precision of the shear cuts and the precise mating that was realized by this method.

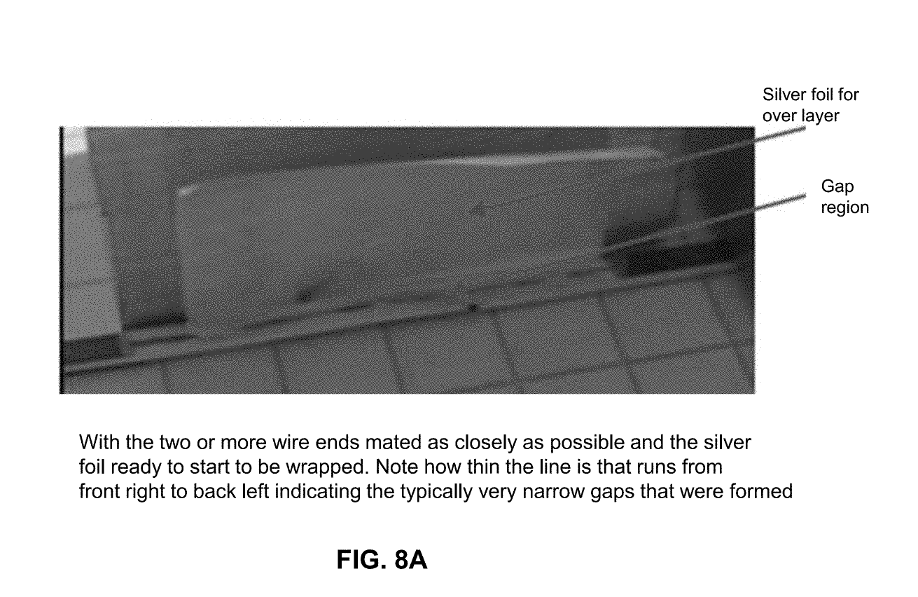

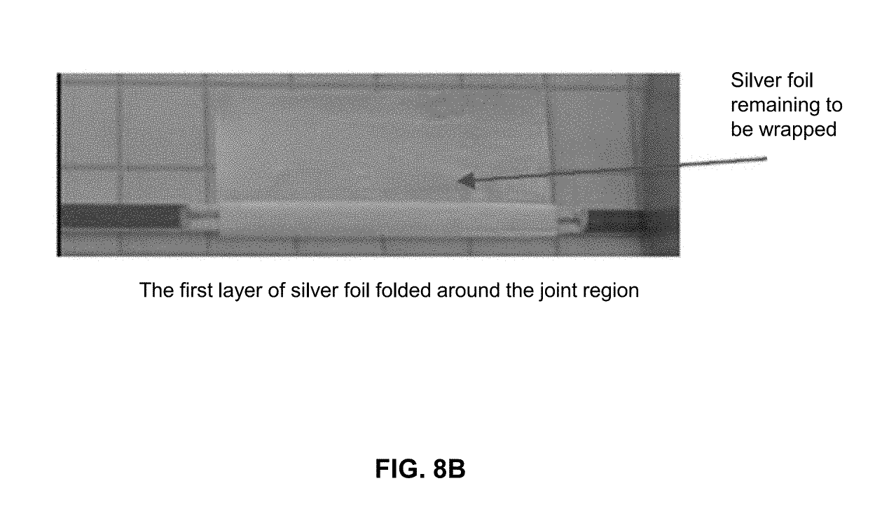

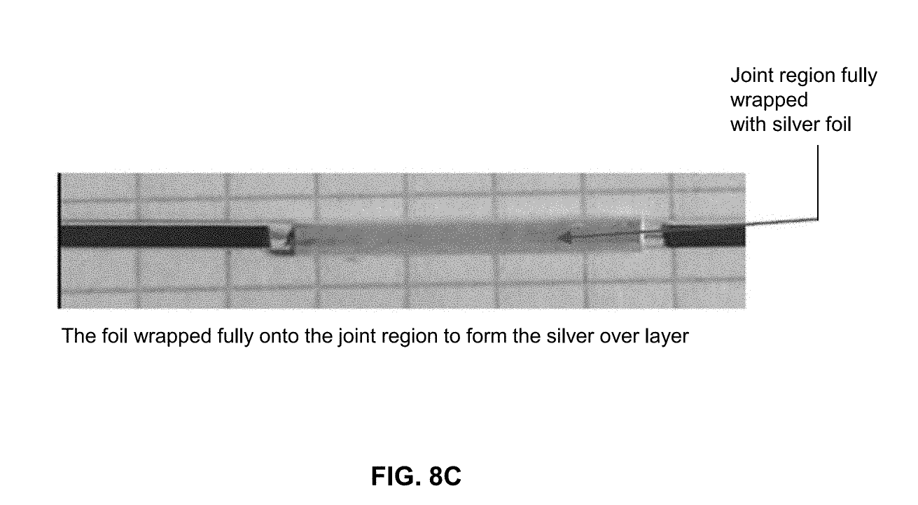

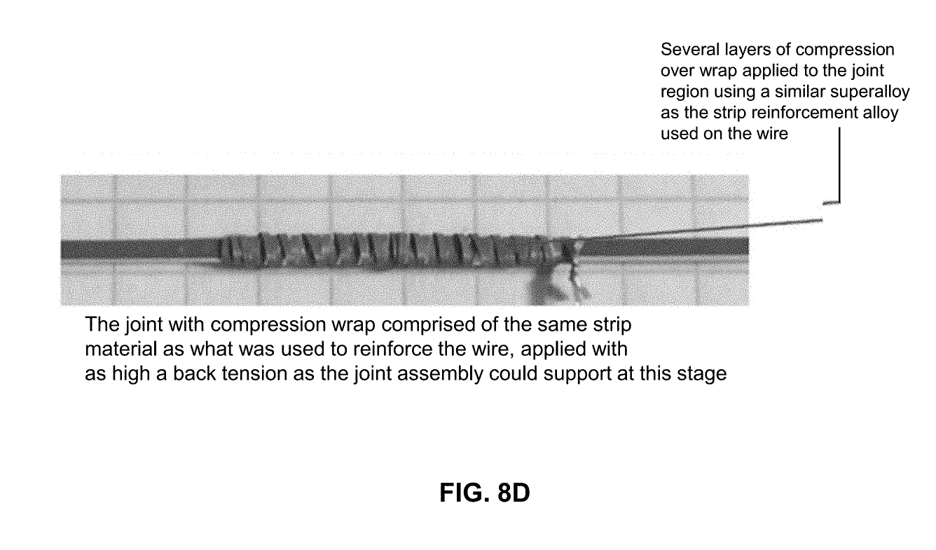

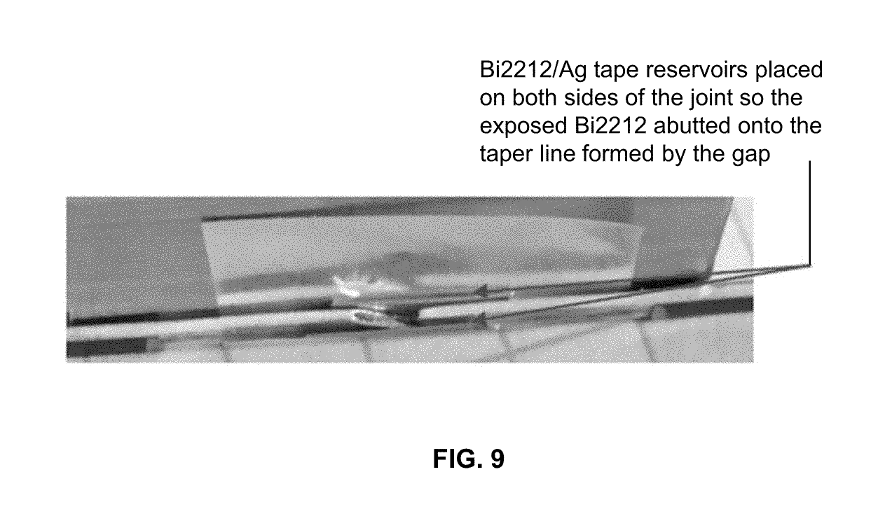

Joint assembly: FIGS. 8A, 8B, 8C, 8D, and FIG. 9 illustrate the manner in which the joints were prepared.

In the case of a simple joint without Bi2212 reservoirs or joint reinforcement strips, the assembly followed the sequence illustrated by the photographs in FIGS. 8A, 813, 8C, and 8D. The two ends were brought together to a precise mating configuration as shown in FIG. 8A, and with the silver foil destined to become the over layer already positioned behind the abutting ends that already has its bottom edge folded under the abutting region. The silver foil is then folded around the joint region as shown in FIG. 8B with one full layer of foil, and in FIG. 8C with about two full layers when the silver foil edge is reached. By this method many more layers can be folded to make the over layer much thicker as may be needed.

In the case where the Bi2212 reservoir is applied in the form of Bi2212/Ag tape, the tape lengths are placed as shown beside the top and bottom surfaces of the mating taper regions and extending some distance past the ends of the taper regions, and also with the side with exposed Bi2212 facing towards the joint. In the case where Bi222 powder was used, a very small, measured amount was fed into the region occupied by the Bi2212/Ag tape reservoirs while the wires being joined were pushed together to keep the powder from going prematurely going excessively into the gap region and increase the gap size. In the case of dense, sintered Bi2212 reservoirs, they are similar in shape to the Bi2212/ Ag tapes shown, and also are inserted as is shown for the case of the Bi2212/Ag tapes. In all cases where reservoirs are used, the silver over layer was also applied by the same kind of technique as illustrated in FIGS. 8A, 8 B, 8 C, and 8 D.

In the case where the joint in strengthened by the same kind of strip reinforcement as is used on the wire, a wider silver foil over layer wrap was used that extended onto the strips of the wires. Then the reinforcement strips were placed on the two larger area opposing sides of the assembly and the compression wrap applied hold it all together until the melt texturing heat treatment sinter bonded the silver over layer to the strips and the joint components while the Bi2212 was also formed into it high Jc configuration across the gap of the joint region.

Melt texture formation: The joined wires were subjected to standard pressure melt texturing treatments although they can just as easily, by one skilled in the art, be subjected to the over pressure types of melt texturing heat treatments.

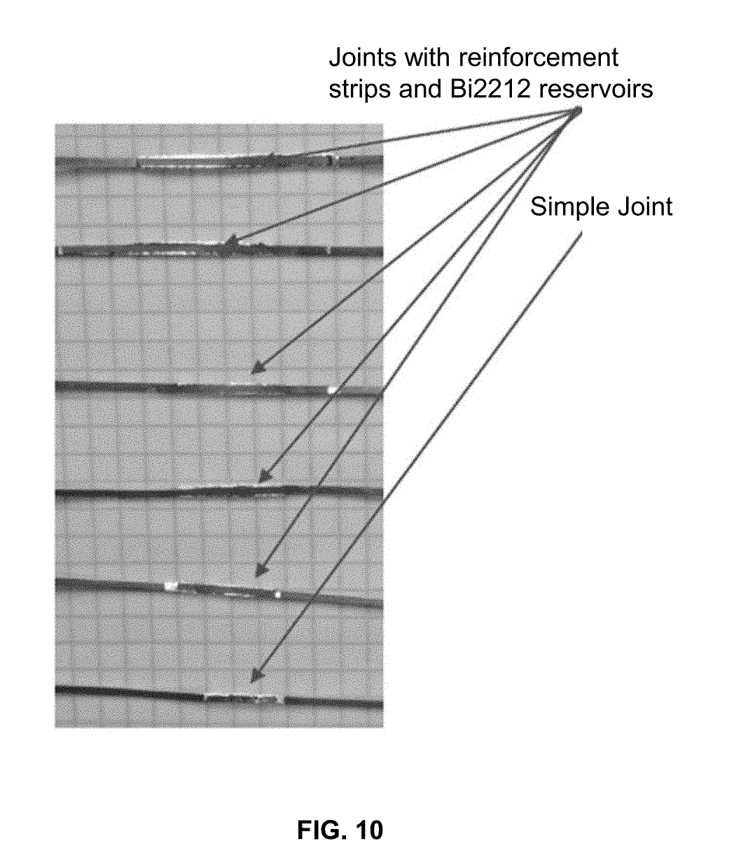

The photograph in FIG. 10 illustrates the appearance of a number of joints that have been made and tested—also illustrating the small and highly useful dimensions of these joints, even with added reinforcement.

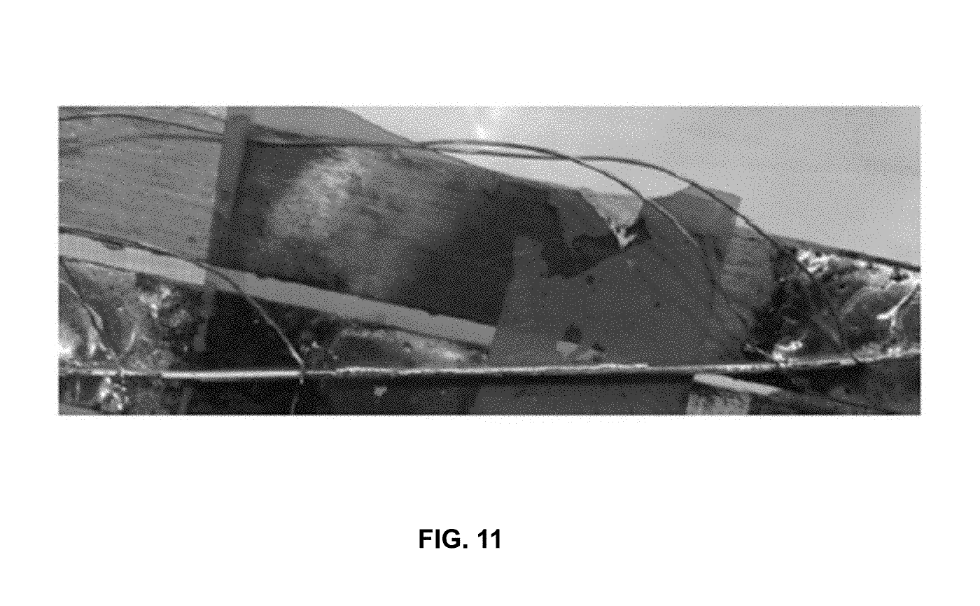

Testing joint critical current levels: The critical currents of the joints were determined using 4 voltage leads in series leading up to and through the joint as shown the by the photo in FIG. 11. Ic was tested at a temperature of 4.2K, using a DC power supply and a 1 micro-volt / cm criterion applied to the I-V data.

### Results

The summary in Table 1 that relates Ic to some of the different joint variations in the study clearly demonstrates that Ic levels in the useful range are attained by thus innovation, for example, all cases where the Ic of the joint is at 40% or greater than the Ic of the wires leading into the joint. The joint Ic's are seen to increase rapidly as the taper angle is decreased to about 5% or lower. The addition of very small Bi2212 reservoirs further increased Ic, to the case with low angle tapers, where the Ic tested through the taper region was 125% of the wire Ic. This illustrates the effectiveness of using small, well placed Bi2212 reservoirs in combination with a very narrow highly elongated gap and with the reservoirs extending beyond the ends of the taper regions.

Further regarding FIG. 7, FIG. 7 illustrates prepared ends of rectangular reinforced Bi2212 based wires showing (A) View B of a wire with region containing reinforcement, with region having its reinforcement strips removed, and end region with taper preps that exposes all Bi2212 filaments on a very oblique section. Note the Bi2212 portion here is 1.35 mm wide by 0.55 mm thick, the reinforcement strips are 1.37 mm wide by 0.1 mm thick. In the case (A), the taper angle is nominally 11 degrees relative to the wire axis, while in (B) taper preps spanning nominally 4 degrees to 12 degrees are shown.

Further regarding FIG. 8, FIG. 8 illustrates a simple joint at different stages of assembly, this one without use of Bi2212 reservoirs or strip reinforcement of the joint.

Further regarding FIG. 9, FIG. 9 illustrates the placement of Bi2212 reservoir tapes on each side of the joint region, with the silver foil acting as the trough holding them in place. This silver foil was subsequently wrapped around the joint as the wires were pushed towards each other.

Further regarding FIG. 10, FIG. 10 illustrates melt textured joint samples spanning some of the configurations described in Table 1. Note how short and similar the dimensions are to the wire dimensions—making them very practical and useful in compact coil designs.

Further regarding FIG. 11, FIG. 11 illustrates an edge view of the Ic test set up for a sample with all the components described and a 5.7 degree taper: strip reinforcement over the joint, 2 Bi2212 reservoir tapes, and silver foil over layer.

TABLE 1
Summary of Ic Results with rectangular wire-based joint variations.

| | | | | | Avg Ic | Avg IC | | | Avg |
|---|---|---|---|---|---|---|---|---|---|
| | | | | Strip over | Joint (4K, | Joint/Ic | Avg Joint | Avg Joint | Overlap |
| Type | Taper | Taper plane | Bi2212 | joint to | self-field, | wire | width | thickness | length |
| # | angle | orientation | reservoir | strengthen | 1 μV/cm) | (%) | (mm) | (mm) | (mm) |
| 1 | 90 | Thru Thickness | No | No | 0 | 0 | 2.0 | 1.4 | <1 mm |
| 2 | 22 | Thru Thickness | No | No | ~0 | 0 | 2.0 | 1.4 | 3.5 |
| 3 | 11.3 | Thru Thickness | No | No | 18 | 3.5 | 2.0 | 1.4 | 7.5 |
| 4 | 5.7 | Thru Thickness | No | No | 95 | 11.2 | 2.0 | 1.4 | 14 |
| 5 | 3.8 | Thru Thickness | No | No | 362 | 42.6 | 2.0 | 1.4 | 21 |
| 6 | 11.3 | Thru Thickness | Yes | No | 340 | 40.0 | 2.4 | 1.4 | 7.5 |
| 7 | 5.7 | Thru Thickness | Yes | No | 341 | 40.1 | 2.4 | 1.4 | 14 |
| 8 | 3.8 | Thru Thickness | Yes | No | 550 | 64.7 | 2.4 | 1.4 | 21 |
| 9 | 5.7 | Thru Thickness | Yes | Yes | 361 | 42.5 | 2.4 | 1.7 | 14 |
| 10 | 3.8 | Thru Thickness | Yes | Yes | 615 | 72.4 | 2.4 | 1.7 | 21 |
| 11 | 11.3 | Thru width | Yes | Yes/No | 365 | 42.9 | 2.4 | 1.7 | 7.5 |
| 12 | 5.7 | Thru width | Yes | Yes/No | 875 | 1.03 | 2.4 | 1.7 | 14 |
| 13 | 3.8 | Thru width | Yes | Yes/No | 1070 | 1.26 | 2.4 | 1.7 | 21 |

For Table 1, bolded rows meet or exceed the typical minimum requirements for use in persistent current magnets. Also, the Ic values of the small angle joints with thin Bi2212 reservoir tapes exceed the wires because the Bi2212 in these tapes must be very well fused with high current density, low angle connections to the Bi2212 in the gap and wires. The average Ic of the wires used in these examples was 850 A at 4.2 K, self-field, and using a 1 microvolt/cm criterion.

### Example: 2: Round Wire

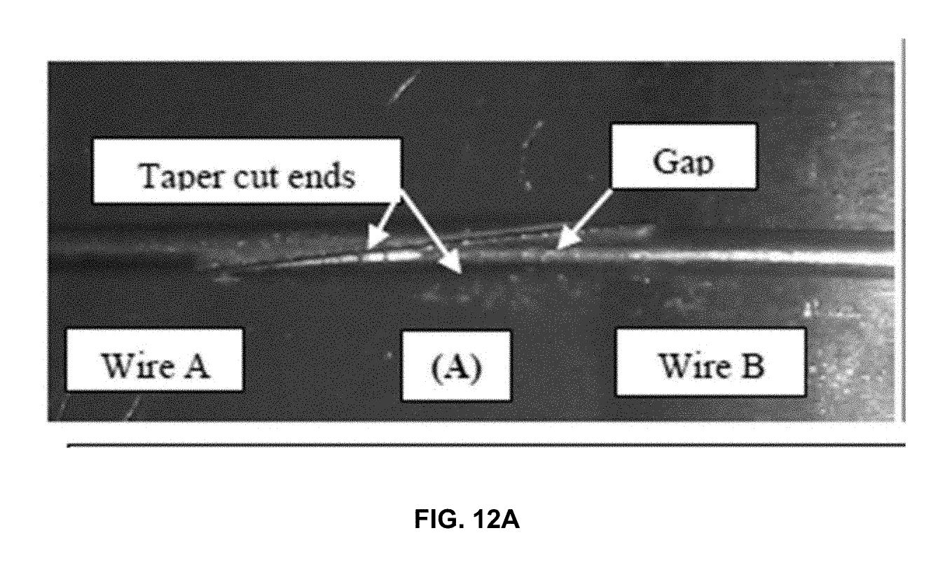

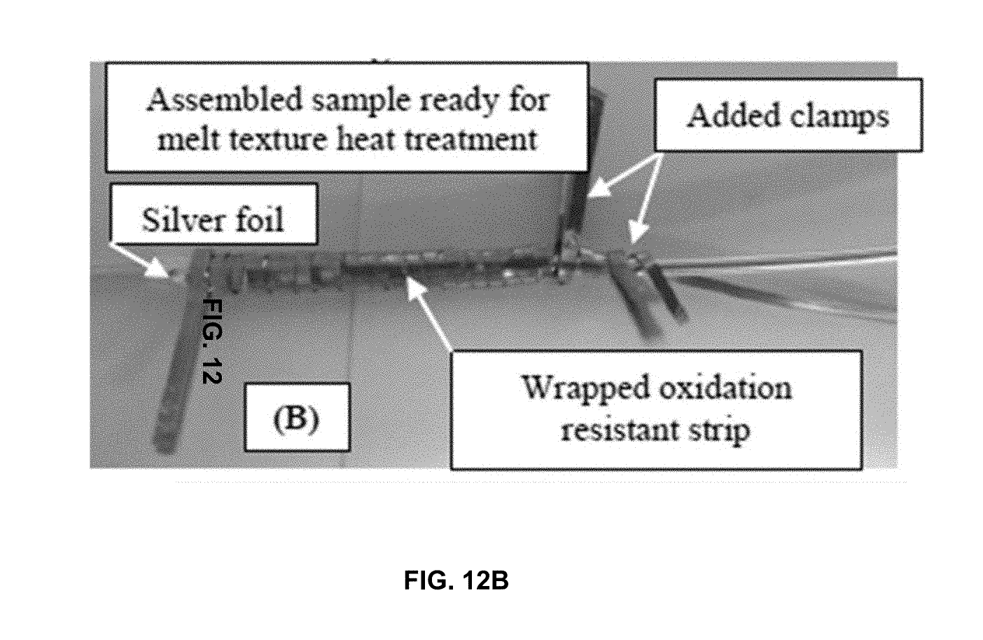

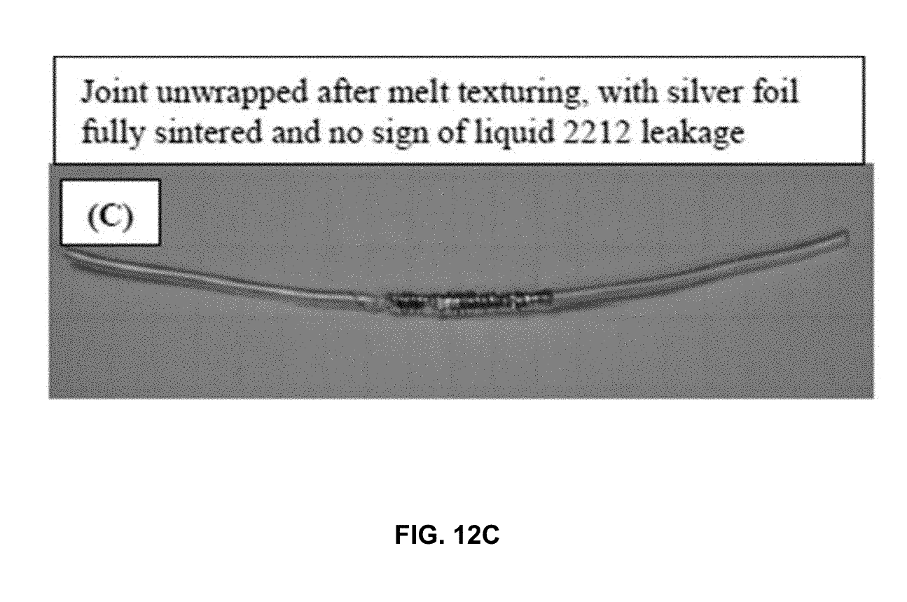

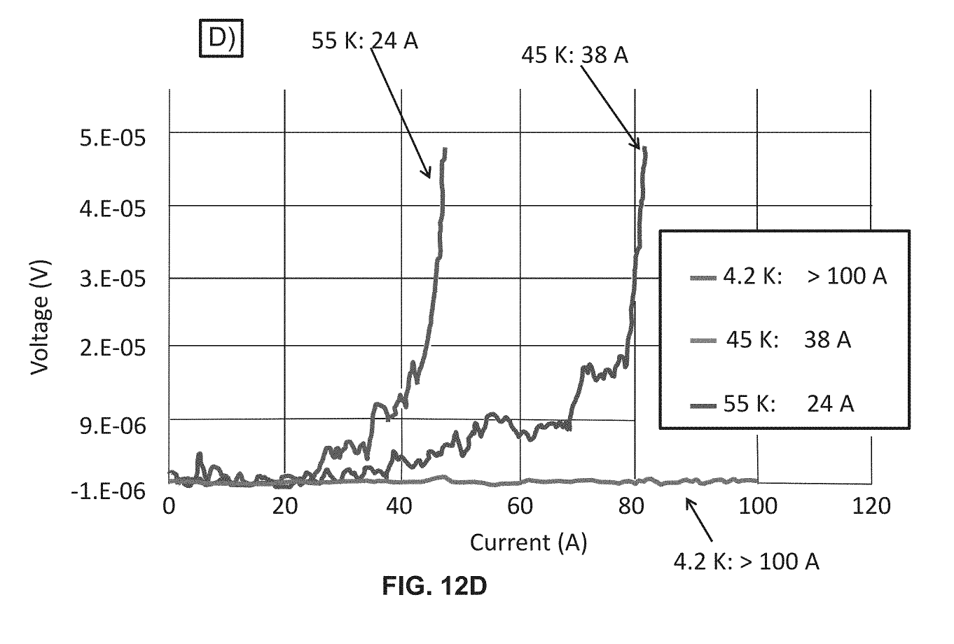

As-drawn multifilament wire samples with a diameter of 1.2 mm and with ˜25 % 2212 oxide content by volume were used to make several joint samples of the type illustrated in FIGS. 3A and 38. Approximately 10° taper cuts were produced on samples ends with a simple sheet metal-cutting shear. Each joint sample was assembled by bringing two taper-cut ends together, as shown in FIG. 12A and aligning them to make the gap uniform and thin, <100 μm. The abutting wire region was then wrapped in about three layers of 50 μm thick silver foil, and tightly wrapped with oxidation resistant superalloy ribbon. Finally, several clamps were applied along the joint region over the wrap to further hold the wire ends in place. The sample shown in FIG. 12B is fully prepared for the melt-texturing heat treatment.

FIGS. 12A-D illustrate (A) wire ends with taper cuts brought together, (B) the assembled joint sample ready for melt texture heat treatment and, (C) joint after heat treatment and superalloy strip removal, and (D) Ic data at three temperature (1 μV/cm Ic criterion, self field, 2212 wire. 1.2 mm diameter)

Results: After standard melt texturing and removal of the superalloy strip, the joint, shown in FIG. 12C, was tested for its Ic at 4.2 K, 45 K, and 55 K in self field with a standard 4-probe method. As summarized in the graph and table of FIG, 12 D, This result also confirms that practical, high-supercurrent Bi2212 superconducting joints are achieved by the designs and fabrication methods described.

Related References, all of which are hereby incorporated by reference in their entireties:

U.S. patent application Ser. No. 15/043,145;

Peng Chen, Ph.D. Dissertation, Processing and Characterization of Superconducting Solenoids Made of Bi-2212/ Ag-Alloy Multifilament Round Wire for High Field Magnet Applications, Florida State University, pp. 87-106 (2016);

G. D. Brittles, T. Mousavi, C. R. M. Grovener, C. Askoy, and S. C. Speller. Persistent current joints between technological superconductors. Superconductor Science and Technology, 28 (9 ):093001, 2015;

J. E. Tkaczyk, R. H. Arendt, P. J. Bednarczyk, M. F. Garbauskas, B. A. Jones, R. J. Kilmer, and K. W. Lay. Superconducting joints formed between powder-in-tube Bi₂Sr₂Ca₂Cu₃O_{z}/Ag tapes. Applied Superconductivity , IEEE Transactions on, 3 (1 ): 946 -948, 1993;

Jung Ho Kim, Kyu Tae Kim, Jinho Joo, and Wansoo Nah. A study on joining method of BiPbSrCaCuO_{z}/ multifilamentary tape. Physica C: Superconductivity, 372376, Part 2(0): 909-912, 2002,

Wei Gui, Guisheng Zou, Aping Wu, Fangbing Zhou, and Jialie Ren. Fabrication of joint Bi2223/Ag superconducting tapes with BSCCO superconducting powders by diffusion bonding. Physica C: Superconductivity, 470 (910 ): 440 -443, 2010;

Yeonjoo Park, Myungwhon Lee, Heesung Ann, Yoon Hyuck Choi, and Haigun Lee. A superconducting joint for GdBA₂Cu₃O_{7δ}-coated conductors. NPG Asia Mater, 6:e98, 2014;

T. Hase, Y. Murakami, S. Hayashi, Y. Kawate, T. Kiyoshi, H. Wada, S. Sairote, and R. Ogawa. Development of Bi-2212 multifilamentary wire for NMR usage. Physica C: Superconductivity, 335(14):6-10, 2000; and

M. J. Leupold and Y. Iwasa. Superconducting joint between multifilamentary wires 1. Joint-making and joint results. Cryogenics.

1. A high temperature superconducting joint comprising:
two tapered Bi2212 wire ends, each of the ends comprising an angle of less than about twenty degrees relative to the longitudinal axis of each of the wires;
an overlap region between the two wire ends;
a gap between the wire ends within the overlap region, an average thickness of the gap being less than about 100 micrometers;
wherein the gap contains aligned Bi2212 grains; and
a silver over-layer encapsulating the wire ends, the overlap region, and the gap, the silver over-layer comprising from about 0.05 millimeters (mm) to about 2 mm in thickness.

2. The high temperature superconducting joint of claim 1, wherein the taper angle is from about 3.5 degrees to about 11.5 degrees.

3. The high temperature superconducting joint of claim 1, wherein the silver-oxide layer comprises at least three layers of silver foil, each layer comprising about 50 microns in thickness.

4. The high temperature superconducting joint of claim 1, wherein the Bi2212 grains are on average aligned to within about plus or minus about twenty degrees of a gap plane, a plane extending in the direction of the length of the gap, approximately perpendicular to the gap thickness.

5. The high temperature superconducting joint of claim 1, where the silver over-layer extends beyond the overlap region along the length of each of the wire ends for a distance of up to about ten centimeters.

6. The high temperature superconducting joint of claim 1, further comprising metal reinforcement strips on opposing sides of the high temperature superconducting joint.

7. A magnetic resonance imaging (MRI) machine or Nuclear magnetic resonance (NIVIR) machine comprising:
a high temperature superconducting wire or tape comprising:
at least one high temperature superconducting joint, the joint comprising:
two tapered Bi2212 wire or tape ends, each of the ends comprising an angle of less than about twenty degrees relative to the longitudinal axis of each of the wires;
an overlap region between the two wire or the tape ends;
a gap between the wire or the tape ends within the overlap region, an average thickness of the gap being less than about 100 micrometers;
wherein the gap contains aligned Bi2212 grains; and
a silver over-layer encapsulating the wire ends, the overlap region, and the gap, the silver over-layer comprising from about 0.05 millimeters (mm) to about 2 mm in thickness.

8. The magnetic resonance imaging (MRI) machine or Nuclear magnetic resonance (NMR) machine of claim 7, wherein the wire or the tape is round wire or rectangular wire.

9. The magnetic resonance imaging (MRI) machine or Nuclear magnetic resonance (NMR) machine of claim 7, wherein the taper angle is from about 3.5 degrees to about 11.5 degrees.

10. The magnetic resonance imaging (MRI) machine or Nuclear magnetic resonance (NMR) machine of claim 7, wherein the silver-oxide layer of the high temperature superconducting joint comprises at least three layers of silver foil, each layer comprising about 50 microns in thickness.

11. The magnetic resonance imaging (MRI) machine or Nuclear magnetic resonance (NMR) machine of claim 7, wherein the Bi2212 grains are aligned on average to within plus or minus about twenty degrees of a gap plane, a plane extending in the direction of the length of the gap, approximately perpendicular to the gap thickness.

12. The magnetic resonance imaging (MRI) machine or Nuclear magnetic resonance (NMR) machine of claim 7, wherein the silver over-layer of the high temperature superconducting joint extends beyond the overlap region along the length of each of the wire or the tape ends for a distance of up to about ten centimeters.

13. The magnetic resonance imaging (MRI) machine or Nuclear magnetic resonance (NMR) machine of claim 7, further comprising metal reinforcement strips on opposing sides of the high temperature superconducting joint.

14. A method for producing a high temperature superconducting joint, the method comprising:
tapering two Bi2212 wire ends such that each of the ends comprises an angle of less than about twenty degrees relative to the longitudinal axis of each of the wires;
overlapping the wire ends, forming an overlap region between the two wire ends;
placing the wire ends such that there is a gap between the wire ends within the overlap region, an average thickness of the gap being less than about 100 micrometers;
filling the gap with Bi2212 liquid by wetting during melt texturing of Bi2212 grains, thereby forming aligned Bi2212 grains; and
encapsulating the wire ends, the overlap region, and the gap, with a silver over-layer, the silver over-layer comprising from about 0.05 millimeters (mm) to about 2 mm in thickness.

15. The method for producing a high temperature superconducting joint of claim 14, wherein the taper angle for each of the wire ends is from about 3.5 degrees to about 11.5 degrees.

16. The method for producing a high temperature superconducting joint of claim 14, wherein the silver-oxide layer of the high temperature superconducting joint comprises at least three layers of silver foil, each layer comprising about 50 microns in thickness.

17. The method for producing a high temperature superconducting joint of claim 14, wherein the Bi2212 grains are aligned to within plus or minus about twenty degrees of a gap plane, a plane extending in the direction of the length of the gap, approximately perpendicular to the gap thickness.

18. The method for producing a high temperature superconducting joint of claim 14, further comprising placing the wire into a magnetic resonance imaging (MRI) machine or Nuclear magnetic resonance (NMR) machine.

19. The method for producing a high temperature superconducting joint of claim 14, further comprising placing reinforcement strips on opposing sides of the high temperature superconducting joint.

20. The method for producing a high temperature superconducting joint of claim 14, where the step of encapsulating further comprises extending the silver over-layer beyond the overlap region along the length of each of the wire ends for a distance of up to about ten centimeters.
